(19) United States
(12) Patent Application Publication
(10) Pub. No.: US 2025/0364152 A1
(43) Pub. Date: Nov. 27, 2025

(54) CONDUCTIVE PASTE

(71) Applicant: Murata Manufacturing Co., Ltd., Nagaokakyo-shi (JP)

(72) Inventors: Takashi OHARA, Nagaokakyo-shi (JP); Hideyasu ONISHI, Nagaokakyo-shi (JP); Hiroaki OCHI, Nagaokakyo-shi (JP)

(21) Appl. No.: 19/293,595

(22) Filed: Aug. 7, 2025

Related U.S. Application Data
(63) Continuation of application No. PCT/JP2024/003419, filed on Feb. 2, 2024.

(30) Foreign Application Priority Data
Feb. 27, 2023 (JP) 2023-028470

(51) Int. Cl. H01B 1/22; H01G 4/008; H01G 4/12; H01G 4/30

(52) U.S. Cl. CPC H01B 1/22; H01G 4/008; H01G 4/12; H01G 4/30

(57) ABSTRACT

A conductive paste for forming inner electrodes of a multilayer ceramic capacitor includes a conductive metal powder, a ceramic powder, an organic solvent, and an organic binder. At least a portion of the ceramic powder includes a powder including an ABO₃-type oxide with a specified ionic radius. A ratio of a six-coordinate ionic radius of an A-site element in ABO₃ to a six-coordinate ionic radius of a metal included in the conductive metal powder is about 0.97 or greater and about 1.02 or less.

### CROSS REFERENCE TO RELATED APPLICATIONS

This application claims the benefit of priority to Japanese Patent Application No. 2023-028470 filed on Feb. 27, 2023 and is a Continuation Application of PCT Application No. PCT/JP2024/003419 filed on Feb. 2, 2024. The entire contents of each application are hereby incorporated herein by reference.

### BACKGROUND OF THE INVENTION

### 1. Field of the Invention

The present application relates to conductive pastes, and more particularly to conductive pastes for the formation of inner electrodes of a multilayer ceramic capacitor.

### 2. Description of the Related Art

A multilayer ceramic capacitor typically includes a multilayer body having multiple ceramic dielectric layers stacked together and multiple inner electrodes arranged along multiple interfaces between the dielectric layers, with each inner electrode along a respective interface, and multiple outer electrodes provided at the outer surface of the multilayer body and electrically coupled to the inner electrodes. The inner electrodes include multiple first inner electrodes and multiple second inner electrodes arranged alternately in the direction of stacking in the multilayer body, and the outer electrodes include a first outer electrode electrically coupled to the first inner electrodes and a second outer electrode electrically coupled to the second inner electrodes.

To reduce the size and increase the capacitance of a multilayer ceramic capacitor in such a structure simultaneously, it is required to form the dielectric layers and inner electrodes as thin layers while increasing the coverage of the inner electrodes (electrode continuity). In general, in the firing step during the manufacture of a multilayer ceramic capacitor, the temperature at which the conductive metal particles included in the conductive paste films to be the inner electrodes sinter is lower than the temperature at which the ceramic material that forms the dielectric layers sinters, which means that the metal particles included in the inner electrodes sinter first. This causes a reduced coverage of the inner electrodes. In particular, inner electrodes formed as thin layers, for example, reduced to a thickness of less than 1.0 μm, are likely to have a low coverage. With such inner electrodes, there is a disadvantage that such a low coverage often hinders increasing the capacitance.

To form thin-layer inner electrodes with a high coverage, therefore, it is necessary to increase the temperature at which the conductive metal particles included in the conductive paste films to be the inner electrodes sinter in the firing step during the manufacture of the multilayer ceramic capacitor. Through this, the temperature at which the metal particles included in the conductive paste films to be the inner electrodes sinter can be brought closer to the temperature at which the ceramic that forms the dielectric layers starts sintering, and thus the onset of shrinkage during sintering can closer between the inner electrodes and the dielectric layers. As a result, the coverage of the inner electrodes increases, allowing a large capacitance to be achieved.

As a way to increase the coverage of the inner electrodes and achieve a large capacitance by the method described above, it is known to add a ceramic material having a composition similar to the composition of the ceramic material that forms the dielectric layers, or, in other words, a common material, to the conductive paste for the formation of the inner electrodes, for example, as described in paragraph [0004] of Japanese Unexamined Patent Application Publication No. 2016-31807. By adding a common material, the onset of sintering of the metal particles included in the conductive paste films to be the inner electrodes can be shifted toward higher temperatures, and thus the temperature at which the metal particles included in the conductive paste films sinter can be brought closer to the temperature at which the ceramic material that forms the dielectric layers sinters.

It is, however, undeniable that even after the addition of a common material to the conductive paste for the formation of inner electrodes, the temperature at which the metal particles included in the conductive paste sinter remains lower than the temperature at which the ceramic material that forms the dielectric layers sinters. Thus, there is a need for further improvement. In particular, for inner electrodes formed as thin layers, for example, reduced to a thickness of less than 1.0 μm, there is a compelling necessity for an effective solution to the issue of a reduced coverage, which hinders increasing the capacitance.

### SUMMARY OF THE INVENTION

Example embodiments of the present invention provide conductive pastes for the formation of inner electrodes that each enable inner electrodes to maintain a relatively high coverage even when provided as thin layers.

An example embodiment of the present invention provides a conductive paste for formation of inner electrodes of a multilayer ceramic capacitor, the paste including a conductive metal powder, a ceramic powder, an organic solvent, and an organic binder. The ceramic powder included in the conductive paste limits a reduction in coverage, and the inventors of example embodiments of the present invention discovered that there is a relationship between a metal of the conductive metal powder included in the conductive paste and an A-site element in an ABO₃-type oxide of the ceramic powder. More specifically, the inventors of example embodiments of the present invention focused on the ionic radius of the metal of the conductive metal powder and the ionic radius of the A-site element in the ABO₃-type oxide of the ceramic powder, discovering that when the ratio between these ionic radii falls within a predetermined range, the ceramic powder contributes more to improving the coverage of the inner electrodes.

Appropriate ratios between the ionic radii, or ratios that contribute to improving the coverage of the inner electrodes, are not fixed but vary depending on the metal species of the conductive metal powder. The inventors of example embodiments of the present invention, however, focused on the fact that although appropriate ratios between the ionic radii vary depending on the metal species of the conductive metal powder, there is a common range that applies across different metal species regarding appropriate ratios between the ionic radii.

In example embodiments of the present invention, therefore, at least a portion of the ceramic powder is a powder made of an ABO₃-type oxide in which the A-site element has a specified ionic radius, and is a powder made of an ABO₃-type oxide for which the ratio of the six-coordinate ionic radius of the A-site element in ABO₃ to the six-coordinate ionic radius of the metal included in the conductive metal powder is about 0.97 or greater and about 1.02 or less.

When the inner electrodes of a multilayer ceramic capacitor include a conductive paste according to an example embodiment of the present invention, the coverage of the inner electrodes can be increased regardless of the metal species of the conductive metal powder. Even if the inner electrodes are provided as thin layers, therefore, a high coverage of the inner electrodes is maintained. As a result, it can be ensured that efforts to increase the capacitance of the multilayer ceramic capacitor are not reduced or prevented.

The above and other elements, features, steps, characteristics and advantages of the present invention will become more apparent from the following detailed description of the example embodiments with reference to the attached drawings.

### BRIEF DESCRIPTION OF DRAWINGS

FIG. 1 is a cross-sectional view schematically illustrating a multilayer ceramic capacitor 1 to which a conductive paste according to an example embodiment of the present invention is applied.

### DETAILED DESCRIPTION OF THE EXAMPLE EMBODIMENTS

Example embodiments of the present invention will be described in detail below with reference to the drawings.

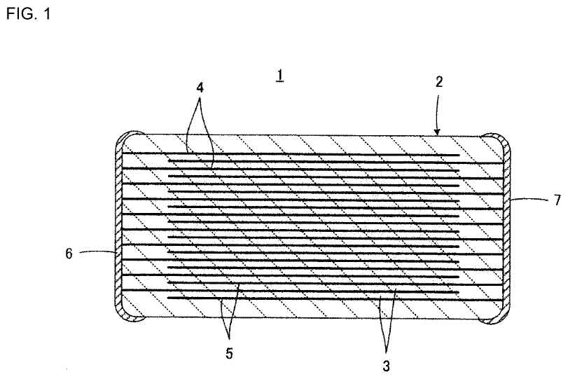

With reference to FIG. 1, the structure of a multilayer ceramic capacitor 1 to which a conductive paste according to example embodiments of the present invention is applied will be described.

The multilayer ceramic capacitor 1 includes a multilayer body 2. The multilayer body 2 includes multiple ceramic dielectric layers 3 stacked together and multiple inner electrodes 4 and 5 extending along the interfaces between the multiple dielectric layers 3. The inner electrodes 4 and 5 include multiple first inner electrodes 4 and multiple second inner electrodes 5 alternately provided in the direction of stacking in the multilayer body 2. At the outer surface of the multilayer body 2, or more specifically the end surfaces facing each other, a first outer electrode 6 and a second outer electrode 7 are provided. The first outer electrode 6 is electrically coupled to the first inner electrodes 4, and the second outer electrode 7 is electrically coupled to the second inner electrodes 5.

The dielectric layers 3 are made of a ceramic material that includes, for example, ABO₃ (A is at least one of Ba, Ca, or Sr, and B is at least one of Ti or Zr.) as a base component. The ceramic material, furthermore, may include the ABO₃ as a base component and further include, for example, at least one of Mn, Mg, Si, Y, Dy, or Gd as a minor component.

The inner electrodes 4 and 5 preferably include, for example, one of nickel, copper, silver, or a silver/palladium alloy as a conductive component. As a characteristic composition, furthermore, the inner electrodes 4 and 5 include, as a ceramic component, an ABO₃-type oxide with a specified ionic radius, for which the ratio of the six-coordinate ionic radius of the A-site element in ABO₃ to the six-coordinate ionic radius of the metal that defines and functions as the above conductive component is, for example, about 0.97 or greater and about 1.02 or less. This ABO₃-type oxide preferably has an ilmenite crystal structure, for example.

As can be seen from the experimental examples described later, in an example embodiment of the present invention, the dielectric layers 3 are made of a ceramic material that includes, for example, at least one of BaTiO₃, SrTiO₃, or CaZrO₃ as a base component. In that case, the inner electrodes 4 and 5 may optionally further include, for example, as a ceramic component, the at least one of BaTiO₃, SrTiO₃, or CaZrO₃ included in the dielectric layers 3 in addition to the ABO₃-type oxide with a specified ionic radius.

The percentage of the ceramic component in the inner electrodes 4 and 5 is, for example, preferably about 5% by mass or more and about 15% by mass or less. The percentage refers to {(the mass of the ceramic component)/(the mass of the ceramic component+the mass of the conductive metal or the alloy including it)}×100 (the same applies hereinafter).

The outer electrodes 6 and 7 are formed by, for example, applying a conductive paste in which Ag or Cu is the base ingredient in the conductive component to the end surfaces of the multilayer body 2 and baking the applied paste. Optionally, the thick films formed through baking may be coated with, for example, Ni plating and Sn plating on the Ni plating.

The multilayer ceramic capacitor 1 is manufactured through, for example, steps such as the following. First, a ceramic slurry including ceramic raw material powders that will form a composition as described above is produced. Then ceramic green sheets are shaped by applying an appropriate sheet shaping method to the ceramic slurry. Then a conductive paste to form each of the inner electrodes 4 and 5 is applied onto predetermined ones of the multiple ceramic green sheets, for example, by printing. Then the multiple ceramic green sheets are stacked and then pressure-bonded to form a raw multilayer body. Then the raw multilayer body is fired. Through this step of firing, the ceramic green sheets turn into the dielectric layers 3. Thereafter, the outer electrodes 6 and 7 are formed at the end surfaces of the multilayer body 2.

The conductive paste to form the inner electrodes 4 and 5 used during the manufacture of the multilayer ceramic capacitor 1 described above is preferably produced as follows.

In the production of the conductive paste, a first step, in which a ceramic powder slurry including a ceramic powder, an organic solvent, and a dispersant is prepared, a second step, in which a metal powder slurry including a conductive metal powder, an organic solvent, and a dispersant is prepared, a third step, in which an organic vehicle including an organic resin component and an organic solvent is prepared, and a fourth step, in which the ceramic powder slurry, the metal powder slurry, and the organic vehicle are mixed, are performed.

To be more specific, in the first step, a ceramic powder slurry is prepared by mixing a ceramic powder and a dispersant into an organic solvent.

The ceramic powder is a powder made of an ABO₃-type oxide with a specified ionic radius as described above. In addition, for example, furthermore, a powder made of at least one of BaTiO₃, SrTiO₃, or CaZrO₃ as a common material may be used. When a powder made of at least one of BaTiO₃, SrTiO₃, or CaZrO₃ is used, it is preferable that, for example, about 10% by volume or more of the ceramic powder is the powder of an ABO₃-type oxide with a specified ionic radius, with the remainder of the ceramic powder being a powder including at least one of BaTiO₃, SrTiO₃, or CaZrO₃ as a base component.

The ABO₃-type oxide with a specified ionic radius is determined by the metal species of the conductive metal powder included in the metal powder slurry prepared in the second step, which will be described later. That is, for example, the ABO₃-type oxide with a specified ionic radius is selected as an ABO₃-type oxide in which the A-site element is an element whose six-coordinate ionic radius relative to the six-coordinate ionic radius of the metal included in the conductive metal powder is about 0.97 or greater and about 1.02 or less, provided that the six-coordinate ionic radius of the metal is determinable. The range of about 0.97 to about 1.02 as ratios between ionic radii is a range derived from the results of the experiments described later.

As stated above, with a ceramic powder made of an ABO₃-type oxide with a specified ionic radius, the reaction that can occur between it and the conductive metal powder included in the metal powder slurry, which will be prepared in the second step, during firing can be reduced. The ceramic powder included in the conductive paste may include the ABO₃ oxide as a base component and further include, for example, at least one of Mn, Mg, Si, Y, Dy, or Gd as a minor component. When the ceramic powder includes such a minor component, the sintering of the metal particles may be effectively reduced to a greater extent as a result of controlled growth of ceramic particles.

The dispersant mixed into the ceramic powder in the first step can be, for example, an anionic polymer dispersant. The organic solvent can be, for example, dihydroterpineol.

In the second step, a metal powder slurry is prepared by mixing a conductive metal powder and a dispersant into an organic solvent. The conductive metal powder is, for example, a powder made of one of nickel, copper, silver, or a silver/palladium alloy. A dispersant and an organic solvent that can be used in the second step are the same as in the first step.

In the third step, an organic vehicle is prepared by mixing an organic resin component into an organic solvent. The organic resin component can be, for example, an ethyl cellulose resin. An organic solvent that can be used in the third step is also the same as in the first step.

In the fourth step, the ceramic powder slurry, metal powder slurry, and organic vehicle described above are mixed. Through this, a conductive paste to form the inner electrodes 4 and 5 is obtained. This conductive paste includes a ceramic powder slurry, and, as stated above, the ceramic powder slurry includes a ceramic powder made of an ABO₃ oxide with a specified ionic radius. The inner electrodes 4 and 5 included in the multilayer ceramic capacitor 1 manufactured through a firing step, therefore, will include an ABO₃ oxide with a specified ionic radius.

The percentage of the ceramic powder in the conductive paste is, for example, preferably about 5% by mass or more and about 15% by mass or less.

Experimental examples conducted to determine the scope of the present invention and verify advantages provided by example embodiments of the present invention will now be described.

### Experimental Example 1: Conductive Metal Powder: Nickel Powder

In Experimental Example 1, a nickel powder was prepared as the conductive metal powder included in the conductive paste for the formation of inner electrodes.

Separately, NiTiO₃, MgTiO₃, and MnTiO₃ were prepared as ABO₃ oxides with a specified ionic radius of the ceramic powder included in the conductive paste for the formation of inner electrodes, and CuTiO₃, BaTiO₃, CaZrO₃, and SrTiO₃ were prepared as other ABO₃ oxides. In Table 1, the “crystal structure,” “coordination number,” “A-site element,” and “ionic radius” are presented for these ABO₃ oxides. Ba, Ca, and Sr are twelve-coordinate when they are in their native perovskite structure, but they are six-coordinate when dissolving in the sites of the six-coordinate element (Ni, Mg, or Mn) in the ilmenite structure. Accordingly, for Ba, Ca, and Sr as well, the “ionic radius” in Table 1 indicates a six-coordinate value.

TABLE 1

| ABO₃ | Crystal | Coordination | A-site | Ionic |
|---|---|---|---|---|
| oxide | structure | number | element | radius [Å] |
| NiTiO₃ | Ilmenite | 6 | Ni | 0.69 |
| MgTiO₃ | Ilmenite | 6 | Mg | 0.72 |
| MnTiO₃ | Ilmenite | 6 | Mn | 0.67 |
| CuTi0₃ | Ilmenite | 6 | Cu | 0.73 |
| BaTiO₃ | Perovskite | 12 | Ba | 1.35 |
| CaZrO₃ | Perovskite | 12 | Ca | 1.00 |
| SrTiO₃ | Perovskite | 12 | Sr | 1.18 |

Experimental Example 1-1, Experimental Example 1-2, and Experimental Example 1-3, which were conducted using different ceramic raw materials for dielectric layers, will now be described.

### Experimental Example 1-1: Base Component of the Ceramic Material of the Dielectric Layers: BaTiO₃

### 1-1-1. Preparation of a BaTiO₃ Ceramic Raw Material That Will Define the Dielectric Layers

As starting materials, powders of BaCO₃ and TiO₂, which were base ingredients, were weighed out and mixed for about 72 hours using a ball mill. Then the resulting mixture was subjected to heat treatment for about 2 hours with the maximum temperature being about 1000° C., yielding a thermally treated powder. Separately, as minor ingredients, powders of MnO, Dy₂O₃, MgO, SiO₂, and BaCO₃ were prepared and weighed out such that the proportions of the minor ingredient powders to the thermally treated powder were 100BaTiO₃+about 0.5Mn+about 1.0Dy+about 1.0Mg+about 1.0Si+about 2.0Ba. These minor ingredient powders were added to the thermally treated powder, the powders were mixed for about 24 hours using a ball mill, and then the resulting mixture was dried. In this manner, a BaTiO₃ ceramic raw material powder was obtained.

### 1-1-2. Preparation of a Conductive Paste for the Formation of Inner Electrodes

A powder of the “ABO₃ oxide” specified in Table 2, which will be provided later, and the above BaTiO₃ ceramic raw material powder for dielectric layers were used as ceramic powders included in the conductive paste for the formation of inner electrodes.

These powders of an “ABO₃ oxide” and BaTiO₃ ceramic raw material powder were weighed out to the “percentages added” specified in Table 2. These powders and dihydroterpineol as an organic solvent and an anionic polymer dispersant as a dispersant were preliminarily mixed in a stirring mill without a medium and then subjected to dispersion treatment in a medium stirring mill. In this manner, a ceramic powder slurry was prepared (first step).

Separately, a metal powder slurry was prepared by subjecting a nickel powder as a conductive metal powder, dihydroterpineol as an organic solvent, and an anionic polymer dispersant as a dispersant to dispersion treatment in a three-roll mill (second step).

An organic vehicle, furthermore, was obtained by mixing an ethyl cellulose resin as an organic resin component with dihydroterpineol, which is an organic solvent (third step).

Thereafter, the metal powder slurry and the ceramic powder slurry were added to the organic vehicle, and mixing and dispersion treatment was performed. In this manner, a conductive paste for the formation of inner electrodes was prepared (fourth step).

Here, the percentage of ceramic powder in the conductive paste for the formation of inner electrodes was set to about 10% by mass.

In Table 2, the ratio of the six-coordinate ionic radius of the A-site element to the six-coordinate ionic radius of nickel, which was to be included in the inner electrodes, or the “ionic radius ratio (A-site element/metallic nickel),” is presented. For sample 8, the ratio of the six-coordinate ionic radius of Ba (about 1.35 Å), indicated in Table 1, to the six-coordinate ionic radius of Ni (about 0.69 Å) is presented.

### 1-1-3. Production of a Multilayer Ceramic Capacitor

A ceramic slurry including the BaTiO₃ ceramic raw material powder prepared in 1-1-1 above was prepared, and then ceramic green sheets were shaped by applying doctor blading to the ceramic slurry. Then the conductive paste for the formation of inner electrodes prepared in 1-1-2 above was applied onto predetermined ones of the multiple ceramic green sheets by screen printing. Then the multiple ceramic green sheets were stacked and then pressure-bonded to form a raw multilayer body. Then the raw multilayer body was fired. Thereafter, outer electrodes were formed at the end surfaces of the sintered multilayer body. In this manner, a sample multilayer ceramic capacitor was produced.

### 1-1-4. Evaluation

TABLE 2

| | | Percentage added | | Ionic radius ratio | | |
|---|---|---|---|---|---|---|
| | | [% by volume] | | (A-site | | |
| | ABO₃ | ABO₃ | | element/metallic | Coverage | |
| Sample | oxide | oxide | BaTiO₃ | nickel) | [%] | Assessment |
| 1 | NiTiO₃ | 100 | 0 | 1.00 | 85 | ∘ |
| 2 | MgTiO₃ | 100 | 0 | 1.04 | 85 | ∘ |
| 3 | MnTiO₃ | 100 | 0 | 0.97 | 84 | ∘ |
| 4 | CuTiO₃ | 100 | 0 | 1.06 | 75 | x |
| 5 | NiTiO₃ | 10 | 90 | 1.00 | 85 | ∘ |
| 6 | MgTiO₃ | 10 | 90 | 1.04 | 85 | ∘ |
| 7 | MnTiO₃ | 10 | 90 | 0.97 | 84 | ∘ |
| 8 | — | — | 100 | 1.96 | 74 | x |

An inner electrode and a dielectric layer located in the middle portion, in the height direction, of the multilayer body included in the sample multilayer ceramic capacitor were torn apart from each other by electric field separation.

Then the vicinity of the middle portion (the position at about ½ in the width direction and about ½ in the length direction) of the exposed inner electrode was observed using a microscope at a magnification of about 100×. By analyzing the obtained image, the percentage of the area that the conductive film as an inner electrode occupied in the exposed portion was determined as the “coverage” presented in Table 2. Samples with a “coverage” of more than about 80% were determined to be good, and “O” was recorded in the “Assessment” section. Samples with a “coverage” of about 80% or less were determined to be poor, and “x” was recorded in the “Assessment” section.

### 1-1-5. Discussion

Samples 1 to 3 and 5 to 7 in Table 2 received an “assessment” of “o.” For these samples 1 to 3 and 5 to 7, the inner electrodes include any of NiTiO₃, MgTiO₃, or MnTiO₃ as an ABO₃ oxide. The inner electrodes, furthermore, include nickel as a conductive component.

Ionic radii are focused on here. First, as indicated in the “NiTiO₃” section in Table 1, the six-coordinate ionic radius of nickel is about 0.69 Å. The six-coordinate ionic radii of the A-site elements in NiTiO₃, MgTiO₃, and MnTiO₃ as the ABO₃ oxides included in the inner electrodes of samples 1 to 3 and 5 to 7, on the other hand, are about 0.69 Å, about 0.72 Å, and about 0.67 Å, respectively, as presented in Table 1.

For samples 1 to 3 and 5 to 7, which were rated “o,” the ratio of the six-coordinate ionic radius of the A-site element in ABO₃ to the six-coordinate ionic radius of the metal included in the conductive metal particles, or the “ionic radius ratio,” is about 0.97 or greater and about 1.04 or less.

Overall, for NiTiO₃, MgTiO₃, and MnTiO₃ as the ABO₃ oxides in samples 1 to 3 and 5 to 7, the six-coordinate ionic radius of the A-site element in ABO₃ is equal to or close to the six-coordinate ionic radius of nickel as the conductive metal to be included in the inner electrodes. The energy difference between the oxide and nickel in the inner electrodes, therefore, is about 0 or small, enabling the oxide to remain in the inner electrode portion rather than being expelled. The oxide acts to improve the heat resistance of the inner electrodes. Presumably, as a result of this, samples 1 to 3 and 5 to 7 achieved a high coverage of about 84% or more.

As can be seen from samples 5 to 7, furthermore, the percentage of NiTiO₃, MgTiO₃, or MnTiO₃ added is not necessarily about 100%. As long as the percentage was about 10% or more, the advantage of improved coverage was observed compared with when none of NiTiO₃, MgTiO₃, or MnTiO₃ was included. In addition, in Experimental Example 1-1, the coverages of samples 5 to 7, in which the percentage of NiTiO₃, MgTiO₃, or MnTiO₃ added is about 10%, exhibit values equal or substantially equal to the coverages of samples 1 to 3, in which the percentage added is about 100%.

In contrast to these, for sample 4, which was rated “x,” the ABO₃ oxide was CuTiO₃. The six-coordinate ionic radius of Cu, which is the A-site element in ABO₃, is about 0.73 Å, as presented in Table 1. Accordingly, the ratio of the six-coordinate ionic radius of Cu to the six-coordinate ionic radius of nickel, or the “ionic radius ratio,” is about 1.06. The “ionic radius ratio,” therefore, fell outside the range of about 0.97 to about 1.04, resulting in a low coverage of about 75%.

As for sample 8, which was also rated “x,” only BaTiO₃ as a common material has been added to the inner electrodes. In this case, Ba is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Ba is, as presented in Table 1, about 1.35 Å. Accordingly, the ratio of the six-coordinate ionic radius of Ba to the six-coordinate ionic radius of nickel, or the “ionic radius ratio,” is about 1.96. As a result, the “ionic radius ratio” fell outside the range of about 0.97 to about 1.04, resulting in a low coverage of about 74%.

For these samples 4 and 8, the “ionic radius ratio” fell outside the range of about 0.97 to about 1.04, resulting in the expulsion of CuTiO₃ and BaTiO₃, respectively, from the inner electrode portion. Presumably, as a result of this, the heat resistance of the inner electrodes was not improved, and the coverage was low.

### Experimental Example 1-2: Base Component of the Ceramic Material of the Dielectric Layers: CaZrO₃

### 1-2-1. Preparation of a CaZrO₃ Ceramic Raw Material That Will Define the Dielectric Layers

As starting materials, powders of CaCO₃ and ZrO₂, which were base ingredients, and powders of MnO, SiO₂, and MgO, which were minor ingredients, were weighed out and mixed for about 72 hours using a ball mill. Then the resulting mixture was subjected to heat treatment for about 2 hours, with the maximum temperature being about 1000° C. In this manner, a CaZrO₃ ceramic raw material powder was obtained.

### 1-2-2. Preparation of a Conductive Paste for the Formation of Inner Electrodes

A powder of the “ABO₃ oxide” specified in Table 3, which will be provided later, and the above CaZrO₃ ceramic raw material powder for dielectric layers were used as ceramic powders included in the conductive paste for the formation of inner electrodes.

The powder of an “ABO₃ oxide” and CaZrO₃ ceramic raw material powder were weighed out to the “percentages added” specified in Table 3, and a conductive paste for the formation of inner electrodes was prepared through the same steps as in the case of Experimental Example 1-1 above.

Here, the percentage of ceramic powder in the conductive paste for the formation of inner electrodes was set to about 10% by mass.

In Table 3, the “ionic radius ratio (A-site element/metallic nickel)” is presented as in the case of Table 2. For sample 18, the ratio of the six-coordinate ionic radius of Ca (1.00 Å), indicated in Table 1, to the six-coordinate ionic radius of Ni (about 0.69 Å) is presented.

### 1-2-3. Production of a Multilayer Ceramic Capacitor

A ceramic slurry including the CaZrO₃ ceramic raw material powder prepared in 1-2-1 above was prepared, and then ceramic green sheets were shaped by applying doctor blading to the ceramic slurry. Then the same steps as in the case of Experimental Example 1-1 were followed to produce a sample multilayer ceramic capacitor.

### 1-2-4. Evaluation

TABLE 3

| | | Percentage added | | Ionic radius ratio | | |
|---|---|---|---|---|---|---|
| | | [% by volume] | | (A-site | | |
| | ABO₃ | ABO₃ | | element/metallic | Coverage | |
| Sample | oxide | oxide | CaZrO₃ | nickel) | [%] | Assessment |
| 11 | NiTiO₃ | 100 | 0 | 1.00 | 84 | ∘ |
| 12 | MgTiO₃ | 100 | 0 | 1.04 | 84 | ∘ |
| 13 | MnTiO₃ | 100 | 0 | 0.97 | 83 | ∘ |
| 14 | CuTiO₃ | 100 | 0 | 1.06 | 75 | x |
| 15 | NiTiO₃ | 10 | 90 | 1.00 | 83 | ∘ |
| 16 | MgTiO₃ | 10 | 90 | 1.04 | 82 | ∘ |
| 17 | MnTiO₃ | 10 | 90 | 0.97 | 81 | ∘ |
| 18 | — | 0 | 100 | 1.45 | 72 | x |

The “coverage” was determined as presented in Table 3 following the same procedure as in the case of Experimental Example 1-1 and evaluated as in Experimental Example 1-1.

### 1-2-5. Discussion

Samples 11 to 13 and 15 to 17 in Table 3 received an “assessment” of “o.” For these samples 11 to 13 and 15 to 17, the inner electrodes include any of NiTiO₃, MgTiO₃, or MnTiO₃ as an ABO₃ oxide. The inner electrodes, furthermore, include nickel as a conductive component.

Ionic radii are focused on here. First, as indicated in the “NiTiO₃” section in Table 1, the six-coordinate ionic radius of nickel is about 0.69 Å. The six-coordinate ionic radii of the A-site elements in NiTiO₃, MgTiO₃, and MnTiO₃ as the ABO₃ oxides included in the inner electrodes of samples 11 to 13 and 15 to 17, on the other hand, are about 0.69 Å, about 0.72 Å, and about 0.67 Å, respectively, as presented in Table 1.

For samples 11 to 13 and 15 to 17, which were rated “o,” the ratio of the six-coordinate ionic radius of the A-site element in ABO₃ to the six-coordinate ionic radius of the metal included in the conductive metal particles, or the “ionic radius ratio,” is about 0.97 or greater and about 1.04 or less.

Overall, for NiTiO₃, MgTiO₃, and MnTiO₃ as the ABO₃ oxides in samples 11 to 13 and 15 to 17, the six-coordinate ionic radius of the A-site element in ABO₃ is equal to or close to the six-coordinate ionic radius of nickel as the conductive metal to be included in the inner electrodes. The energy difference between the oxide and nickel in the inner electrodes, therefore, is about 0 or small, enabling the oxide to remain in the inner electrode portion rather than being expelled. The oxide acts to improve the heat resistance of the inner electrodes. Presumably, as a result of this, samples 11 to 13 and 15 to 17 achieved a high coverage of about 81% or more.

As can be seen from samples 15 to 17, furthermore, the percentage of NiTiO₃, MgTiO₃, or MnTiO₃ added is not necessarily about 100%. As long as the percentage was about 10% or more, the advantage of improved coverage was observed compared with when none of NiTiO₃, MgTiO₃, or MnTiO₃ was included.

In contrast to these, for sample 14, which was rated “x,” the ABO₃ oxide was CuTiO₃. The six-coordinate ionic radius of Cu, which is the A-site element in ABO₃, is about 0.73 Å, as presented in Table 1. Accordingly, the ratio of the six-coordinate ionic radius of Cu to the six-coordinate ionic radius of nickel, or the “ionic radius ratio,” is about 1.06. The “ionic radius ratio,” therefore, fell outside the range of about 0.97 to about 1.04, resulting in a low coverage of about 75%.

As for sample 18, which was also rated “x,” only CaZrO₃ as a common material has been added to the inner electrodes. In this case, Ca is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Ca is, as presented in Table 1, about 1.00 Å. Accordingly, the ratio of the six-coordinate ionic radius of Ca to the six-coordinate ionic radius of nickel, or the “ionic radius ratio,” is about 1.45. As a result, the “ionic radius ratio” fell outside the range of about 0.97 to about 1.04, resulting in a low coverage of about 72%.

For these samples 14 and 18, the “ionic radius ratio” fell outside the range of about 0.97 to about 1.04, resulting in the expulsion of CuTiO₃ and CaZrO₃, respectively, from the inner electrode portion. Presumably, as a result of this, the heat resistance of the inner electrodes was not improved, and the coverage was low.

### Experimental Example 1-3: Base Component of the Ceramic Material of the Dielectric Layers: SrTiO₃

### 1-3-1. Preparation of a SrTiO₃ Ceramic Raw Material That Will Define the Dielectric Layers

As starting materials, powders of SrCO₃ and TiO₂, which were base ingredients, and powders of MnO, SiO₂, and MgO, which were minor ingredients, were weighed out and mixed for about 72 hours using a ball mill. Then the resulting mixture was subjected to heat treatment for about 2 hours, with the maximum temperature being about 1000° C. In this manner, a SrTiO₃ ceramic raw material powder was obtained.

### 1-3-2. Preparation of a Conductive Paste for the Formation of Inner Electrodes

A powder of the “ABO₃ oxide” specified in Table 4, which will be provided later, and the above SrTiO₃ ceramic raw material powder for dielectric layers were used as ceramic powders included in the conductive paste for the formation of inner electrodes.

These powders of an “ABO₃ oxide” and SrTiO₃ ceramic raw material powder were weighed out to the “percentages added” specified in Table 4, and a conductive paste for the formation of inner electrodes was prepared through the same steps as in the case of Experimental Example 1-1 above.

Here, the percentage of ceramic powder in the conductive paste for the formation of inner electrodes was set to about 10% by mass.

In Table 4, the “ionic radius ratio (A-site element/metallic nickel)” is presented as in the case of Table 2. For sample 28, the ratio of the six-coordinate ionic radius of Sr (about 1.18 Å), indicated in Table 1, to the six-coordinate ionic radius of Ni (about 0.69 Å) is presented.

### 1-3-3. Production of a Multilayer Ceramic Capacitor

A ceramic slurry including the SrTiO₃ ceramic raw material powder prepared in 1-3-1 above was prepared, and then ceramic green sheets were shaped by applying doctor blading to the ceramic slurry. Then the same steps as in the case of Experimental Example 1-1 were followed to produce a sample multilayer ceramic capacitor.

### 1-3-4. Evaluation

TABLE 4

| | | Percentage added | | Ionic radius ratio | | |
|---|---|---|---|---|---|---|
| | | [% by volume] | | (A-site | | |
| | ABO₃ | ABO₃ | | element/metallic | Coverage | |
| Sample | oxide | oxide | SrTiO₃ | nickel) | [%] | Assessment |
| 21 | NiTiO₃ | 100 | 0 | 1.00 | 83 | ∘ |
| 22 | MgTiO₃ | 100 | 0 | 1.04 | 83 | ∘ |
| 23 | MnTiO₃ | 100 | 0 | 0.97 | 82 | ∘ |
| 24 | CuTiO₃ | 100 | 0 | 1.06 | 72 | x |
| 25 | NiTiO₃ | 10 | 90 | 1.00 | 82 | ∘ |
| 26 | MgTiO₃ | 10 | 90 | 1.04 | 82 | ∘ |
| 27 | MnTiO₃ | 10 | 90 | 0.97 | 80 | ∘ |
| 28 | — | — | 100 | 1.71 | 70 | x |

The “coverage” was determined as presented in Table 4 following the same procedure as in the case of Experimental Example 1-1 and evaluated as in Experimental Example 1-1.

### 1-3-5. Discussion

Samples 21 to 23 and 25 to 27 in Table 4 received an “assessment” of “0.” For these samples 21 to 23 and 25 to 27, the inner electrodes include any of NiTiO₃, MgTiO₃, or MnTiO₃ as an ABO₃ oxide. The inner electrodes, furthermore, include nickel as a conductive component.

Ionic radii are focused on here. First, as indicated in the “NiTiO₃” section in Table 1, the six-coordinate ionic radius of nickel is about 0.69 Å. The six-coordinate ionic radii of the A-site elements in NiTiO₃, MgTiO₃, and MnTiO₃ as the ABO₃ oxides included in the inner electrodes of samples 21 to 23 and 25 to 27, on the other hand, are about 0.69 Å, about 0.72 Å, and about 0.67 Å, respectively, as presented in Table 1.

For samples 21 to 23 and 25 to 27, which were rated “o,” the ratio of the six-coordinate ionic radius of the A-site element in ABO₃ to the six-coordinate ionic radius of the metal included in the conductive metal particles, or the “ionic radius ratio,” is about 0.97 or greater and about 1.04 or less.

Overall, for NiTiO₃, MgTiO₃, and MnTiO₃ as the ABO₃ oxides in samples 21 to 23 and 25 to 27, the six-coordinate ionic radius of the A-site element in ABO₃ is equal to or close to the six-coordinate ionic radius of nickel as the conductive metal to be included in the inner electrodes. The energy difference between the oxide and nickel in the inner electrodes, therefore, is about 0 or small, enabling the oxide to remain in the inner electrode portion rather than being expelled. The oxide acts to improve the heat resistance of the inner electrodes. Presumably, as a result of this, samples 21 to 23 and 25 to 27 achieved a coverage exceeding about 80%.

As can be seen from samples 25 to 27, furthermore, the percentage of NiTiO₃, MgTiO₃, or MnTiO₃ added is not necessarily about 100%. As long as the percentage was about 10% or more, the advantage of improved coverage was observed compared with when none of NiTiO₃, MgTiO₃, or MnTiO₃ was included.

In contrast to these, for sample 24, which was rated “x,” the ABO₃ oxide was CuTiO₃. The six-coordinate ionic radius of Cu, which is the A-site element in ABO₃, is about 0.73 Å, as presented in Table 1. Accordingly, the ratio of the six-coordinate ionic radius of Cu to the six-coordinate ionic radius of nickel, or the “ionic radius ratio,” is about 1.06. The “ionic radius ratio,” therefore, fell outside the range of about 0.97 to about 1.04, resulting in a low coverage of about 72%.

As for sample 28, which was also rated “x,” only SrTiO₃ as a common material has been added to the inner electrodes. In this case, Sr is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Sr is, as presented in Table 1, about 1.18 Å. Accordingly, the ratio of the six-coordinate ionic radius of Sr to the six-coordinate ionic radius of nickel, or the “ionic radius ratio,” is about 1.71. As a result, the “ionic radius ratio” fell outside the range of about 0.97 to about 1.04, resulting in a low coverage of about 70%.

For these samples 24 and 28, the “ionic radius ratio” fell outside the range of about 0.97 to about 1.04, resulting in the expulsion of CuTiO₃ and SrTiO₃, respectively, from the inner electrode portion. Presumably, as a result of this, the heat resistance of the inner electrodes was not improved, and the coverage was low.

### Experimental Example 2: Conductive Metal Powder: Copper Powder

In Experimental Example 2, a copper powder was prepared as the conductive metal powder included in the conductive paste for the formation of inner electrodes.

Separately, CuTiO₃, CoTiO₃, and CrTiO₃ were prepared as ABO₃ oxides with a specified ionic radius of the ceramic powder included in the conductive paste for the formation of inner electrodes, and BaTiO₃, CaZrO₃, and SrTiO₃ were prepared as other ABO₃ oxides. In Table 5, the “crystal structure,” “coordination number,” “A-site element,” and “ionic radius” are presented for these ABO₃ oxides. Ba, Ca, and Sr are twelve-coordinate when they are in their native perovskite structure, but they are six-coordinate when dissolving in the sites of the six-coordinate element (Cu, Co, or Cr) in the ilmenite structure. Accordingly, for Ba, Ca, and Sr as well, the “ionic radius” in Table 5 indicates a six-coordinate value.

TABLE 5

| ABO₃ | Crystal | Coordination | A-site | Ionic |
|---|---|---|---|---|
| oxide | structure | number | element | radius [Å] |
| CuTiO₃ | Ilmenite | 6 | Cu | 0.77 |
| CoTiO₃ | Ilmenite | 6 | Co | 0.74 |
| CrTi0₃ | Ilmenite | 6 | Cr | 0.80 |
| BaTiO₃ | Perovskite | 12 | Ba | 1.35 |
| CaZrO₃ | Perovskite | 12 | Ca | 1.00 |
| SrTiO₃ | Perovskite | 12 | Sr | 1.18 |

Experimental Example 2-1, Experimental Example 2-2, and Experimental Example 2-3, which were conducted using different ceramic raw materials for dielectric layers, will now be described.

### Experimental Example 2-1: Base Component of the Ceramic Material of the Dielectric Layers: BaTiO₃

### 2-1-1. Preparation of a BaTiO₃ Ceramic Raw Material That Will Define the Dielectric Layers

A BaTiO₃ ceramic raw material powder was obtained through the same steps as in the case of Experimental Example 1-1.

### 2-1-2. Preparation of a Conductive Paste for the Formation of Inner Electrodes

A powder of the “ABO₃ oxide” specified in Table 6, which will be provided later, and the above BaTiO₃ ceramic raw material powder for dielectric layers were used as ceramic powders included in the conductive paste for the formation of inner electrodes.

These powders of an “ABO₃ oxide” and BaTiO₃ ceramic raw material powder were weighed out to the “percentages added” specified in Table 6, and a conductive paste for the formation of inner electrodes was prepared through the same steps as in the case of Experimental Example 1-1 above.

Here, the percentage of ceramic powder in the conductive paste for the formation of inner electrodes was set to about 10% by mass.

In Table 6, the ratio of the six-coordinate ionic radius of the A-site element to the six-coordinate ionic radius of copper, which was to be included in the inner electrodes, or the “ionic radius ratio (A-site element/metallic copper),” is presented. For sample 37, the ratio of the six-coordinate ionic radius of the Ba element (about 1.35 Å), indicated in Table 5, to the six-coordinate ionic radius of copper (about 0.77 Å) is presented.

### 2-1-3. Production of a Multilayer Ceramic Capacitor

A ceramic slurry including the BaTiO₃ ceramic raw material powder prepared in 2-1-1 above was prepared, and then ceramic green sheets were shaped by applying doctor blading to the ceramic slurry. Then the same steps as in the case of Experimental Example 1-1 were followed to produce a sample multilayer ceramic capacitor.

### 2-1-4. Evaluation

TABLE 6

| | | Percentage added | | Ionic radius ratio | | |
|---|---|---|---|---|---|---|
| | | [% by volume] | | (A-site | | |
| | ABO₃ | ABO₃ | | element/metallic | Coverage | |
| Sample | oxide | oxide | BaTiO₃ | copper | [%] | Assessment |
| 31 | CuTiO₃ | 100 | 0 | 1.00 | 85 | ∘ |
| 32 | CoTiO₃ | 100 | 0 | 0.96 | 85 | ∘ |
| 33 | CrTiO₃ | 100 | 0 | 1.04 | 84 | ∘ |
| 34 | CuTiO₃ | 10 | 90 | 1.00 | 85 | ∘ |
| 35 | CoTiO₃ | 10 | 90 | 0.96 | 85 | ∘ |
| 36 | CrTiO₃ | 10 | 90 | 1.04 | 84 | ∘ |
| 37 | — | — | 100 | 1.75 | 74 | x |

The “coverage” was determined as presented in Table 6 following the same procedure as in the case of Experimental Example 1-1 and evaluated as in Experimental Example 1-1.

### 2-1-5. Discussion

Samples 31 to 36 in Table 6 received an “assessment” of “o.” For these samples 31 to 36, the inner electrodes include any of CuTiO₃, CoTiO₃, or CrTiO₃ as an ABO₃ oxide. The inner electrodes, furthermore, include copper as a conductive component.

Ionic radii are focused on here. First, as indicated in the “CuTiO₃” section in Table 5, the six-coordinate ionic radius of copper is about 0.77 Å. The six-coordinate ionic radii of the A-site elements in CuTiO₃, CoTiO₃, and CrTiO₃ as the ABO₃ oxides included in the inner electrodes of samples 31 to 36, on the other hand, are about 0.77 Å, about 0.74 Å, and about 0.80 Å, respectively, as presented in Table 5.

For samples 31 to 36, which were rated “o,” the ratio of the six-coordinate ionic radius of the A-site element in ABO₃ to the six-coordinate ionic radius of copper, or the “ionic radius ratio,” is about 0.96 or greater and about 1.04 or less.

Overall, for CuTiO₃, CoTiO₃, and CrTiO₃ as the ABO₃ oxides in samples 31 to 36, the six-coordinate ionic radius of the A-site element in ABO₃ is equal to or close to the six-coordinate ionic radius of copper as the conductive metal to be included in the inner electrodes. The energy difference between the oxide and copper in the inner electrodes, therefore, is about 0 or small, enabling the oxide to remain in the inner electrode portion rather than being expelled. The oxide acts to improve the heat resistance of the inner electrodes. Presumably, as a result of this, samples 31 to 36 achieved a high coverage of about 84% or more.

As can be seen from samples 34 to 36, furthermore, the percentage of CuTiO₃, CoTiO₃, or CrTiO₃ added is not necessarily about 100%. As long as the percentage was about 10% or more, the advantage of improved coverage was observed compared with when none of CuTiO₃, CoTiO₃, or CrTiO₃ was included. In addition, it is noted that in Experimental Example 2-1, the coverages of samples 34 to 36, in which the percentage of CuTiO₃, CoTiO₃, or CrTiO₃ added is about 10%, exhibit values equal or substantially equal to the coverages of samples 31 to 33, in which the percentage added is about 100%.

In contrast to these, for sample 37, which was rated “x,” only BaTiO₃ as a common material has been added to the inner electrodes. In this case, Ba is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Ba is, as presented in Table 5, about 1.35 Å. Accordingly, the ratio of the six-coordinate ionic radius of Ba to the six-coordinate ionic radius of copper, or the “ionic radius ratio,” is about 1.75. As a result, the “ionic radius ratio” fell outside the range of about 0.96 to about 1.04, resulting in a low coverage of about 74%.

For sample 37, the “ionic radius ratio” fell outside the range of about 0.96 to about 1.04, resulting in the expulsion of BaTiO₃ from the inner electrode portion. Presumably, as a result of this, the heat resistance of the inner electrodes was not improved, and the coverage was low.

### Experimental Example 2-2: Base Component of the Ceramic Material of the Dielectric Layers: CaZrO₃

### 2-2-1. Preparation of a CaZrO₃ Ceramic Raw Material That Will Define the Dielectric Layers

A CaZrO₃ ceramic raw material powder was obtained through the same steps as in the case of Experimental Example 1-2.

### 2-2-2. Preparation of a Conductive Paste for the Formation of Inner Electrodes

A powder of the “ABO₃ oxide” specified in Table 7, which will be provided later, and the above CaZrO₃ ceramic raw material powder for dielectric layers were used as ceramic powders included in the conductive paste for the formation of inner electrodes.

These powders of an “ABO₃ oxide” and CaZrO₃ ceramic raw material powder were weighed out to the “percentages added” specified in Table 7, and a conductive paste for the formation of inner electrodes was prepared through the same steps as in the case of Experimental Example 2-1 above.

Here, the percentage of ceramic powder in the conductive paste for the formation of inner electrodes was set to about 10% by mass.

In Table 7, the “ionic radius ratio (A-site element/metallic copper)” is presented as in the case of Table 6. For sample 47, the ratio of the six-coordinate ionic radius of the Ca element (about 1.00 Å), indicated in Table 5, to the six-coordinate ionic radius of copper (about 0.77 Å) is presented.

### 2-2-3. Production of a Multilayer Ceramic Capacitor

A ceramic slurry including the CaZrO₃ ceramic raw material powder prepared in 2-2-1 above was prepared, and then ceramic green sheets were shaped by applying doctor blading to the ceramic slurry. Then the same steps as in the case of Experimental Example 2-1 were followed to produce a sample multilayer ceramic capacitor.

### 2-2-4. Evaluation

TABLE 7

| | | Percentage added | | Ionic radius ratio | | |
|---|---|---|---|---|---|---|
| | | [% by volume] | | (A-site | | |
| | ABO₃ | ABO₃ | | element/metallic | Coverage | |
| Sample | oxide | oxide | CaZrO₃ | copper) | [%] | Assessment |
| 41 | CuTiO₃ | 100 | 0 | 1.00 | 84 | ∘ |
| 42 | CoTiO₃ | 100 | 0 | 0.96 | 84 | ∘ |
| 43 | CrTiO₃ | 100 | 0 | 1.04 | 83 | ∘ |
| 44 | CuTiO₃ | 10 | 90 | 1.00 | 83 | ∘ |
| 45 | CoTiO₃ | 10 | 90 | 0.96 | 82 | ∘ |
| 46 | CrTiO₃ | 10 | 90 | 1.04 | 81 | ∘ |
| 47 | — | 0 | 100 | 1.30 | 72 | x |

The “coverage” was determined as presented in Table 7 following the same procedure as in the case of Experimental Example 2-1 and evaluated as in Experimental Example 2-1.

### 2-2-5. Discussion

Samples 41 to 46 in Table 7 received an “assessment” of “o.” For these samples 41 to 46, the inner electrodes include any of CuTiO₃, CoTiO₃, or CrTiO₃ as an ABO₃ oxide. The inner electrodes, furthermore, include copper as a conductive component.

Ionic radii are focused on here. First, as indicated in the “CuTiO₃” section in Table 5, the six-coordinate ionic radius of copper is about 0.77 Å. The six-coordinate ionic radii of the A-site elements in CuTiO₃, CoTiO₃, and CrTiO₃ as the ABO₃ oxides included in the inner electrodes of samples 41 to 46, on the other hand, are about 0.77 Å, about 0.74 Å, and about 0.80 Å, respectively, as presented in Table 5.

For samples 41 to 46, which were rated “o,” the ratio of the six-coordinate ionic radius of the A-site element in ABO₃ to the six-coordinate ionic radius of copper, or the “ionic radius ratio,” is about 0.96 or greater and about 1.04 or less.

Overall, for CuTiO₃, CoTiO₃, and CrTiO₃ as the ABO₃ oxides in samples 41 to 46, the six-coordinate ionic radius of the A-site element in ABO₃ is equal to or close to the six-coordinate ionic radius of copper as the conductive metal to be included in the inner electrodes. The energy difference between the oxide and copper in the inner electrodes, therefore, is about 0 or small, enabling the oxide to remain in the inner electrode portion rather than being expelled. The oxide acts to improve the heat resistance of the inner electrodes. Presumably, as a result of this, samples 41 to 46 achieved a high coverage of about 81% or more.

As can be seen from samples 44 to 46, furthermore, the percentage of CuTiO₃, CoTiO₃, or CrTiO₃ added is not necessarily about 100%. As long as the percentage was about 10% or more, the advantage of improved coverage was observed compared with when none of CuTiO₃, CoTiO₃, or CrTiO₃ was included.

In contrast to these, for sample 47, which was rated “x,” only CaZrO₃ as a common material has been added to the inner electrodes. In this case, Ca is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Ca is, as presented in Table 5, about 1.00 Å. Accordingly, the ratio of the six-coordinate ionic radius of Ca to the six-coordinate ionic radius of copper, or the “ionic radius ratio,” is about 1.30. As a result, the “ionic radius ratio” fell outside the range of about 0.96 to about 1.04, resulting in a low coverage of about 72%.

For sample 47, the “ionic radius ratio” fell outside the range of about 0.96 to about 1.04, resulting in the expulsion of CaZrO₃ from the inner electrode portion. Presumably, as a result of this, the heat resistance of the inner electrodes was not improved, and the coverage was low.

### Experimental Example 2-3: Base Component of the Ceramic Material of the Dielectric Layers: SrTiO

### 2-3-1. Preparation of a SrTiO₃ Ceramic Raw Material That Will Constitute the Dielectric Layers

A SrTiO₃ ceramic raw material powder was obtained through the same steps as in the case of Experimental Example 1-3.

### 2-3-2. Preparation of a Conductive Paste for the Formation of Inner Electrodes

A powder of the “ABO₃ oxide” specified in Table 8, which will be provided later, and the above SrTiO₃ ceramic raw material powder for dielectric layers were used as ceramic powders included in the conductive paste for the formation of inner electrodes.

These powders of an “ABO₃ oxide” and SrTiO₃ ceramic raw material powder were weighed out to the “percentages added” specified in Table 8, and a conductive paste for the formation of inner electrodes was prepared through the same steps as in the case of Experimental Example 2-1 above.

Here, the percentage of ceramic powder in the conductive paste for the formation of inner electrodes was set to about 10% by mass.

In Table 8, the “ionic radius ratio (A-site element/metallic copper)” is presented as in the case of Table 6. For sample 57, the ratio of the six-coordinate ionic radius of the Sr element (about 1.18 Å), indicated in Table 5, to the six-coordinate ionic radius of copper (about 0.77 Å) is presented.

### 2-3-3. Production of a Multilayer Ceramic Capacitor

A ceramic slurry including the SrTiO₃ ceramic raw material powder prepared in 2-3-1 above was prepared, and then ceramic green sheets were shaped by applying doctor blading to the ceramic slurry. Then the same steps as in the case of Experimental Example 2-1 were followed to produce a sample multilayer ceramic capacitor.

### 2-3-4. Evaluation

TABLE 8

| | | | | Ionic radius ratio | | |
|---|---|---|---|---|---|---|
| | | Percentage added | | (A-site | | |
| | ABO₃ | [% by volume] | | element/metallic | Coverage | |
| Sample | oxide | ABO₃ oxide | SrTiO₃ | copper) | [%] | Assessment |
| 51 | CuTiO₃ | 100 | 0 | 1.00 | 83 | ∘ |
| 52 | CoTiO₃ | 100 | 0 | 0.96 | 83 | ∘ |
| 53 | CrTiO₃ | 100 | 0 | 1.04 | 82 | ∘ |
| 54 | CuTiO₃ | 10 | 90 | 1.00 | 82 | ∘ |
| 55 | CoTiO₃ | 10 | 90 | 0.96 | 82 | ∘ |
| 56 | CrTiO₃ | 10 | 90 | 1.04 | 80 | ∘ |
| 57 | — | — | 100 | 1.53 | 70 | x |

The “coverage” was determined as presented in Table 8 following the same procedure as in the case of Experimental Example 2-1 and evaluated as in Experimental Example 2-1.

### 2-3-5. Discussion

Samples 51 to 56 in Table 8 received an “assessment” of “o.” For these samples 51 to 56, the inner electrodes include any of CuTiO₃, CoTiO₃, or CrTiO₃ as an ABO₃ oxide. The inner electrodes, furthermore, include copper as a conductive component.

Ionic radii are focused on here. First, as indicated in the “CuTiO₃” section in Table 5, the six-coordinate ionic radius of copper is about 0.77 Å. The six-coordinate ionic radii of the A-site elements in CuTiO₃, CoTiO₃, and CrTiO₃ as the ABO₃ oxides included in the inner electrodes of samples 51 to 56, on the other hand, are about 0.77 Å, about 0.74 Å, and about 0.80 Å, respectively, as presented in Table 5.

For samples 51 to 56, which were rated “o,” the ratio of the six-coordinate ionic radius of the A-site element in ABO₃ to the six-coordinate ionic radius of copper, or the “ionic radius ratio,” is about 0.96 or greater and about 1.04 or less.

Overall, for CuTiO₃, CoTiO₃, and CrTiO₃ as the ABO₃ oxides in samples 51 to 56, the six-coordinate ionic radius of the A-site element in ABO₃ is equal to or close to the six-coordinate ionic radius of copper as the conductive metal to be included in the inner electrodes. The energy difference between the oxide and copper in the inner electrodes, therefore, is about 0 or small, allowing the oxide to remain in the inner electrode portion rather than being expelled. The oxide acts to improve the heat resistance of the inner electrodes. Presumably, as a result of this, samples 51 to 56 achieved a coverage exceeding about 80%.

As can be seen from samples 54 to 56, furthermore, the percentage of CuTiO₃, CoTiO₃, or CrTiO₃ added is not necessarily about 100%. As long as the percentage was about 10% or more, the advantage of improved coverage was observed compared with when none of CuTiO₃, CoTiO₃, or CrTiO₃ was included.

In contrast to these, for sample 57, which was rated “x,” only SrTiO₃ as a common material has been added to the inner electrodes. In this case, Sr is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Sr is, as presented in Table 5, about 1.18 Å. Accordingly, the ratio of the six-coordinate ionic radius of Sr to the six-coordinate ionic radius of copper, or the “ionic radius ratio,” is about 1.53. As a result, the “ionic radius ratio” fell outside the range of about 0.96 to about 1.04, resulting in a low coverage of about 70%.

For sample 57, the “ionic radius ratio” fell outside the range of about 0.96 to about 1.04, resulting in the expulsion of SrTiO₃ from the inner electrode portion. Presumably, as a result of this, the heat resistance of the inner electrodes was not improved, and the coverage was low.

### Experimental Example 3: Conductive Metal Powder: Powder

In Experimental Example 3, a silver powder was prepared as the conductive metal powder included in the conductive paste for the formation of inner electrodes.

Separately, AgTiO₃, EuTiO₃, and NaTiO₃ were prepared as ABO₃ oxides with a specified ionic radius of the ceramic powder included in the conductive paste for the formation of inner electrodes, and CuTiO₃, SrTiO₃, BaTiO₃, and CaZrO₃ were prepared as other ABO₃ oxides. In Table 9, the “crystal structure,” “coordination number,” “A-site element,” and “ionic radius” are presented for these ABO₃ oxides. It should be noted that Sr, Ba, and Ca are twelve-coordinate when they are in their native perovskite structure, but they are six-coordinate when dissolving in the sites of the six-coordinate element (Ag, Eu, or Na) in the ilmenite structure. Accordingly, for Sr, Ba, and Ca as well, the “ionic radius” in Table 9 indicates a six-coordinate value.

TABLE 9

| ABO₃ | Crystal | Coordination | A-site | Ionic |
|---|---|---|---|---|
| oxide | structure | number | element | radius [Å] |
| AgTiO₃ | Ilmenite | 6 | Ag | 1.15 |
| EuTiO₃ | Ilmenite | 6 | Eu | 1.17 |
| NaTi0₃ | Ilmenite | 6 | Na | 1.02 |
| CuTiO₃ | Ilmenite | 6 | Cu | 0.73 |
| SrTiO₃ | Perovskite | 12 | Sr | 1.18 |
| BaTiO₃ | Perovskite | 12 | Ba | 1.35 |
| CaZrO₃ | Perovskite | 12 | Ca | 1.00 |

Experimental Example 3-1, Experimental Example 3-2, and Experimental Example 3-3, which were conducted using different ceramic raw materials for dielectric layers, will now be described.

### Experimental Example 3-1: Base Component of the Ceramic Material of the Dielectric Layers: BaTiO₃

### 3-1-1. Preparation of a BaTiO₃ Ceramic Raw Material That Will Define the Dielectric Layers

A BaTiO₃ ceramic raw material powder was obtained through the same steps as in the case of Experimental Example 1-1.

### 3-1-2. Preparation of a Conductive Paste for the Formation of Inner Electrodes

A powder of the “ABO₃ oxide” specified in Table 10, which will be provided later, and the above BaTiO₃ ceramic raw material powder for dielectric layers were used as ceramic powders included in the conductive paste for the formation of inner electrodes.

These powders of an “ABO₃ oxide” and BaTiO₃ ceramic raw material powder were weighed out to the “percentages added” specified in Table 10, and a conductive paste for the formation of inner electrodes was prepared through the same steps as in the case of Experimental Example 1-1 above.

Here, the percentage of ceramic powder in the conductive paste for the formation of inner electrodes was set to about 10% by mass.

In Table 10, the ratio of the six-coordinate ionic radius of the A-site element to the six-coordinate ionic radius of silver, which was to be included in the inner electrodes, or the “ionic radius ratio (A-site element/metallic silver),” is presented. For sample 68, the ratio of the six-coordinate ionic radius of the Ba element (about 1.35 Å), indicated in Table 9, to the six-coordinate ionic radius of silver (about 1.15 Å) is presented.

### 3-1-3. Production of a Multilayer Ceramic Capacitor

A ceramic slurry including the BaTiO₃ ceramic raw material powder prepared in 3-1-1 above was prepared, and then ceramic green sheets were shaped by applying doctor blading to the ceramic slurry. Then the same steps as in the case of Experimental Example 1-1 were followed to produce a sample multilayer ceramic capacitor.

### 3-1-4. Evaluation

TABLE 10

| | | Percentage added | | Ionic radius ratio | | |
|---|---|---|---|---|---|---|
| | | [% by volume] | | (A-site | | |
| | ABO₃ | ABO₃ | | element/metallic | Coverage | |
| Sample | oxide | oxide | BaTiO₃ | silver) | [%] | Assessment |
| 61 | AgTiO₃ | 100 | 0 | 1.00 | 85 | ∘ |
| 62 | EuTiO₃ | 100 | 0 | 1.02 | 85 | ∘ |
| 63 | NaTiO₃ | 100 | 0 | 0.89 | 84 | ∘ |
| 64 | SrTiO₃ | 100 | 0 | 1.03 | 76 | x |
| 65 | AgTiO₃ | 10 | 90 | 1.00 | 83 | ∘ |
| 66 | EuTiO₃ | 10 | 90 | 1.02 | 83 | ∘ |
| 67 | NaTiO₃ | 10 | 90 | 0.89 | 82 | ∘ |
| 68 | — | — | 100 | 1.17 | 75 | x |

The “coverage” was determined as presented in Table 10 following the same procedure as in the case of Experimental Example 1-1 and evaluated as in Experimental Example 1-1.

### 3-1-5. Discussion

Samples 61 to 63 and 65 to 67 in Table 10 received an “assessment” of “o.” For these samples 61 to 63 and 65 to 67, the inner electrodes include any of AgTiO₃, EuTiO₃, or NaTiO₃ as an ABO₃ oxide. The inner electrodes, furthermore, include silver as a conductive component.

Ionic radii are focused on here. First, as indicated in the “AgTiO₃” section in Table 9, the six-coordinate ionic radius of silver is about 1.15 Å. The six-coordinate ionic radii of the A-site elements in AgTiO₃, EuTiO₃, and NaTiO₃ as the ABO₃ oxides included in the inner electrodes of samples 61 to 63 and 65 to 67, on the other hand, are about 1.15 Å, about 1.17 Å, and about 1.02 Å, respectively, as presented in Table 9.

For samples 61 to 63 and 65 to 67, which were rated “o,” the ratio of the six-coordinate ionic radius of the A-site element in ABO₃ to the six-coordinate ionic radius of silver, or the “ionic radius ratio,” is about 0.89 or greater and about 1.02 or less.

Overall, for AgTiO₃, EuTiO₃, and NaTiO₃ as the ABO₃ oxides in samples 61 to 63 and 65 to 67, the six-coordinate ionic radius of the A-site element in ABO₃ is equal to or close to the six-coordinate ionic radius of silver as the conductive metal to be included in the inner electrodes. The energy difference between the oxide and silver in the inner electrodes, therefore, is about 0 or small, enabling the oxide to remain in the inner electrode portion rather than being expelled, The oxide acts to improve the heat resistance of the inner electrodes. Presumably, as a result of this, samples 61 to 63 and 65 to 67 achieved a high coverage of about 82% or more.

As can be seen from samples 65 to 67, furthermore, the percentage of AgTiO₃, EuTiO₃, or NaTiO₃ added is not necessarily about 100%. As long as the percentage was about 10% or more, the advantage of improved coverage was observed compared with when none of AgTiO₃, EuTiO₃, or NaTiO₃ was included.

In contrast to these, for sample 64, which was rated “x,” the ABO₃ oxide was SrTiO₃. The six-coordinate ionic radius of Sr, which is the A-site element in ABO₃, is about 1.18 Å, as presented in Table 9. Accordingly, the ratio of the six-coordinate ionic radius of Sr to the six-coordinate ionic radius of silver, or the “ionic radius ratio,” is about 1.03. The “ionic radius ratio,” therefore, fell outside the range of about 0.89 to about 1.02, resulting in a low coverage of about 76%.

As for sample 68, which was also rated “x,” only BaTiO₃ as a common material has been added to the inner electrodes. In this case, Ba is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Ba is, as presented in Table 9, about 1.35 Å. Accordingly, the ratio of the six-coordinate ionic radius of Ba to the six-coordinate ionic radius of silver, or the “ionic radius ratio,” is about 1.17. As a result, the “ionic radius ratio” fell outside the range of about 0.89 to about 1.02, resulting in a low coverage of about 75%.

For these samples 64 and 68, the “ionic radius ratio” fell outside the range of about 0.89 to about 1.02, resulting in the expulsion of BaTiO₃ from the inner electrode portion. Presumably, as a result of this, the heat resistance of the inner electrodes was not improved, and the coverage was low.

### Experimental Example 3-2: Base Component of the Ceramic Material of the Dielectric Layers: CaZrO₃

### 3-2-1. Preparation of a CaZrO₃ Ceramic Raw Material That Will Define the Dielectric Layers

A CaZrO₃ ceramic raw material powder was obtained through the same steps as in the case of Experimental Example 1-2.

### 3-2-2. Preparation of a Conductive Paste for the Formation of Inner Electrodes

A powder of the “ABO₃ oxide” specified in Table 11, which will be provided later, and the above CaZrO₃ ceramic raw material powder for dielectric layers were used as ceramic powders included in the conductive paste for the formation of inner electrodes.

These powders of an “ABO₃ oxide” and CaZrO₃ ceramic raw material powder were weighed out to the “percentages added” specified in Table 11, and a conductive paste for the formation of inner electrodes was prepared through the same steps as in the case of Experimental Example 3-1 above.

Here, the percentage of ceramic powder in the conductive paste for the formation of inner electrodes was set to about 10% by mass.

In Table 11, the “ionic radius ratio (A-site element/metallic silver)” is presented as in the case of Table 10. For sample 78, the ratio of the six-coordinate ionic radius of the Ca element (about 1.00 Å), indicated in Table 9, to the six-coordinate ionic radius of silver (about 1.15 Å) is presented.

### 3-2-3. Production of a Multilayer Ceramic Capacitor

A ceramic slurry including the CaZrO₃ ceramic raw material powder prepared in 3-2-1 above was prepared, and then ceramic green sheets were shaped by applying doctor blading to the ceramic slurry. Then the same steps as in the case of Experimental Example 3-1 were followed to produce a sample multilayer ceramic capacitor.

### 3-2-4. Evaluation

TABLE 11

| | | Percentage added | | Ionic radius ratio | | |
|---|---|---|---|---|---|---|
| | | [% by volume] | | (A-site | | |
| | ABO₃ | ABO₃ | | element/metallic | Coverage | |
| Sample | oxide | oxide | CaZrO₃ | silver) | [%] | Assessment |
| 71 | AgTiO₃ | 100 | 0 | 1.00 | 84 | ∘ |
| 72 | EuTiO₃ | 100 | 0 | 1.02 | 84 | ∘ |
| 73 | NaTiO₃ | 100 | 0 | 0.89 | 83 | ∘ |
| 74 | CuTiO₃ | 100 | 0 | 0.63 | 75 | x |
| 75 | AgTiO₃ | 10 | 90 | 1.00 | 83 | ∘ |
| 76 | EuTiO₃ | 10 | 90 | 1.02 | 82 | ∘ |
| 77 | NaTiO₃ | 10 | 90 | 0.89 | 81 | ∘ |
| 78 | — | — | 100 | 0.87 | 72 | x |

The “coverage” was determined as presented in Table 11 following the same procedure as in the case of Experimental Example 3-1 and evaluated as in Experimental Example 3-1.

### 3-2-5. Discussion

Samples 71 to 73 and 75 to 77 in Table 11 received an “assessment” of “o.” For these samples 71 to 73 and 75 to 77, the inner electrodes include any of AgTiO₃, EuTiO₃, or NaTiO₃ as an ABO₃ oxide. The inner electrodes, furthermore, include silver as a conductive component.

Ionic radii are focused on here. First, as indicated in the “AgTiO₃” section in Table 9, the six-coordinate ionic radius of silver is about 1.15 Å. The six-coordinate ionic radii of the A-site elements in AgTiO₃, EuTiO₃, and NaTiO₃ as the ABO₃ oxides included in the inner electrodes of samples 71 to 73 and 75 to 77, on the other hand, are about 1.15 Å, about 1.17 Å, and about 1.02 Å, respectively, as presented in Table 9.

For samples 71 to 73 and 75 to 77, which were rated “o,” the ratio of the six-coordinate ionic radius of the A-site element in ABO₃ to the six-coordinate ionic radius of silver, or the “ionic radius ratio,” is about 0.89 or greater and about 1.02 or less.

Overall, for AgTiO₃, EuTiO₃, and NaTiO₃ as the ABO₃ oxides in samples 71 to 73 and 75 to 77, the six-coordinate ionic radius of the A-site element in ABO₃ is equal to or close to the six-coordinate ionic radius of silver as the conductive metal to be included in the inner electrodes. The energy difference between the oxide and silver in the inner electrodes, therefore, is about 0 or small, enabling the oxide to remain in the inner electrode portion rather than being expelled. The oxide acts to improve the heat resistance of the inner electrodes. Presumably, as a result of this, samples 71 to 73 and 75 to 77 achieved a high coverage of about 81% or more.

As can be seen from samples 75 to 77, furthermore, the percentage of AgTiO₃, EuTiO₃, or NaTiO₃ added is not necessarily about 100%. As long as the percentage was about 10% or more, the advantage of improved coverage was observed compared with when none of AgTiO₃, EuTiO₃, or NaTiO₃ was included.

In contrast to these, for sample 74, which was rated “x,” the ABO₃ oxide was CuTiO₃. The six-coordinate ionic radius of Cu, which is the A-site element in ABO₃, is about 0.73 Å, as presented in Table 9. Accordingly, the ratio of the six-coordinate ionic radius of Cu to the six-coordinate ionic radius of silver, or the “ionic radius ratio,” is about 0.63. The “ionic radius ratio,” therefore, fell outside the range of about 0.89 to about 1.02, resulting in a low coverage of about 75%.

As for sample 78, which was also rated “x,” only CaZrO₃ as a common material has been added to the inner electrodes. In this case, Ca is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Ca is, as presented in Table 9, about 1.00 Å. Accordingly, the ratio of the six-coordinate ionic radius of Ca to the six-coordinate ionic radius of silver, or the “ionic radius ratio,” is about 0.87. As a result, the “ionic radius ratio” fell outside the range of about 0.89 to about 1.02, resulting in a low coverage of about 72%.

For these samples 74 and 78, the “ionic radius ratio” fell outside the range of about 0.89 to about 1.02, resulting in the expulsion of CaZrO₃ from the inner electrode portion. Presumably, as a result of this, the heat resistance of the inner electrodes was not improved, and the coverage was low.

### Experimental Example 3-3: Base Component of the Ceramic Material of the Dielectric Layers: SrTiO₃

### 3-3-1. Preparation of a SrTiO₃ Ceramic Raw Material That Will Define the Dielectric Layers

A SrTiO₃ ceramic raw material powder was obtained through the same steps as in the case of Experimental Example 1-3.

### 3-3-2. Preparation of a Conductive Paste for the Formation of Inner Electrodes

A powder of the “ABO₃ oxide” specified in Table 12, which will be provided later, and the above SrTiO₃ ceramic raw material powder for dielectric layers were used as ceramic powders included in the conductive paste for the formation of inner electrodes.

These powders of an “ABO₃ oxide” and SrTiO₃ ceramic raw material powder were weighed out to the “percentages added” specified in Table 12, and a conductive paste for the formation of inner electrodes was prepared through the same steps as in the case of Experimental Example 3-1 above.

Here, the percentage of ceramic powder in the conductive paste for the formation of inner electrodes was set to about 10% by mass.

In Table 12, the “ionic radius ratio (A-site element/metallic silver)” is presented as in the case of Table 10. For sample 88, the ratio of the six-coordinate ionic radius of the Sr element (about 1.18 Å), indicated in Table 9, to the six-coordinate ionic radius of silver (about 1.15 Å) is presented.

### 3-3-3. Production of a Multilayer Ceramic Capacitor

A ceramic slurry including the SrTiO₃ ceramic raw material powder prepared in 3-3-1 above was prepared, and then ceramic green sheets were shaped by applying doctor blading to the ceramic slurry. Then the same steps as in the case of Experimental Example 3-1 were followed to produce a sample multilayer ceramic capacitor.

### 3-3-4. Evaluation

TABLE 12

| | | Percentage added | | Ionic radius ratio | | |
|---|---|---|---|---|---|---|
| | | [% by volume] | | (A-site | | |
| | ABO₃ | ABO₃ | | element/metallic | Coverage | |
| Sample | oxide | oxide | SrTiO₃ | silver) | [%] | Assessment |
| 81 | AgTiO₃ | 100 | 0 | 1.00 | 83 | ∘ |
| 82 | EuTiO₃ | 100 | 0 | 1.02 | 83 | ∘ |
| 83 | NaTiO₃ | 100 | 0 | 0.89 | 82 | ∘ |
| 84 | CuTiO₃ | 100 | 0 | 0.63 | 72 | x |
| 85 | AgTiO₃ | 10 | 90 | 1.00 | 82 | ∘ |
| 86 | EuTiO₃ | 10 | 90 | 1.02 | 82 | ∘ |
| 87 | NaTiO₃ | 10 | 90 | 0.89 | 80 | ∘ |
| 88 | — | — | 100 | 1.03 | 70 | x |

The “coverage” was determined as presented in Table 12 following the same procedure as in the case of Experimental Example 3-1 and evaluated as in Experimental Example 3-1.

### 3-3-5. Discussion

Samples 81 to 83 and 85 to 87 in Table 12 received an “assessment” of “o.” For these samples 81 to 83 and 85 to 87, the inner electrodes include any of AgTiO₃, EuTiO₃, or NaTiO₃ as an ABO₃ oxide. The inner electrodes, furthermore, include silver as a conductive component.

Ionic radii are focused on here. First, as indicated in the “AgTio₃” section in Table 9, the six-coordinate ionic radius of silver is about 1.15 Å. The six-coordinate ionic radii of the A-site elements in AgTiO₃, EuTiO₃, and NaTiO₃ as the ABO₃ oxides included in the inner electrodes of samples 81 to 83 and 85 to 87, on the other hand, are about 1.15 Å, about 1.17 Å, and about 1.02 Å, respectively, as presented in Table 9.

For samples 81 to 83 and 85 to 87, which were rated “o,” the ratio of the six-coordinate ionic radius of the A-site element in ABO₃ to the six-coordinate ionic radius of silver, or the “ionic radius ratio,” is about 0.89 or greater and about 1.02 or less.

Overall, for AgTiO₃, EuTiO₃, and NaTiO₃ as the ABO₃ oxides in samples 81 to 83 and 85 to 87, the six-coordinate ionic radius of the A-site element in ABO₃ is equal to or close to the six-coordinate ionic radius of silver as the conductive metal to be included in the inner electrodes. The energy difference between the oxide and silver in the inner electrodes, therefore, is about 0 or small, enabling the oxide to remain in the inner electrode portion rather than being expelled. The oxide acts to improve the heat resistance of the inner electrodes. Presumably, as a result of this, samples 81 to 83 and 85 to 87 achieved a coverage exceeding about 80%.

As can be seen from samples 85 to 87, furthermore, the percentage of AgTiO₃, EuTiO₃, or NaTiO₃ added is not necessarily about 100%. As long as the percentage was about 10% or more, the advantage of improved coverage was observed compared with when none of AgTiO₃, EuTiO₃, or NaTiO₃ was included.

In contrast to these, for sample 84, which was rated “x,” the ABO₃ oxide was CuTiO₃. The six-coordinate ionic radius of Cu, which is the A-site element in ABO₃, is about 0.73 Å, as presented in Table 9. Accordingly, the ratio of the six-coordinate ionic radius of Cu to the six-coordinate ionic radius of silver, or the “ionic radius ratio,” is about 0.63. The “ionic radius ratio,” therefore, fell outside the range of about 0.89 to about 1.02, resulting in a low coverage of about 72%.

As for sample 88, which was also rated “x,” only SrTiO₃ as a common material has been added to the inner electrodes. In this case, Sr is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Sr is, as presented in Table 9, about 1.18 Å. Accordingly, the ratio of the six-coordinate ionic radius of Sr to the six-coordinate ionic radius of silver, or the “ionic radius ratio,” is about 1.03. As a result, the “ionic radius ratio” fell outside the range of about 0.89 to about 1.02, resulting in a low coverage of about 70%.

For these samples 84 and 88, the “ionic radius ratio” fell outside the range of about 0.89 to about 1.02, resulting in the expulsion of SrTiO₃ from the inner electrode portion. Presumably, as a result of this, the heat resistance of the inner electrodes was not improved, and the coverage was low.

### Experimental Example 4: Conductive Metal Powder: Silver/Palladium Alloy Powder

In Experimental Example 4, a silver/palladium alloy powder made of an alloy of about 70 atm % silver and about 30 atm % palladium was prepared as the conductive metal powder included in the conductive paste for the formation of inner electrodes.

Separately, (Ag_{0.7}, Pd_{0.3}) TiO₃, NaTiO₃, and EuTiO₃ were prepared as ABO₃ oxides with a specified ionic radius of the ceramic powder included in the conductive paste for the formation of inner electrodes, and BaTiO₃, CaZrO₃, and SrTiO₃ were prepared as other ABO₃ oxides. In Table 13, the “crystal structure,” “coordination number,” “A-site element,” and “ionic radius” are presented for these ABO₃ oxides. Ba, Ca, and Sr are twelve-coordinate when they are in their native perovskite structure, but they are six-coordinate when dissolving in the sites of the six-coordinate element (Ag/Pd, Na, or Eu) in the ilmenite structure. Accordingly, for Ba, Ca, and Sr as well, the “ionic radius” in Table 13 indicates a six-coordinate value.

TABLE 13

| ABO₃ | Crystal | Coordination | A-site | Ionic |
|---|---|---|---|---|
| oxide | structure | number | element | radius [Å] |
| (Ag, Pd)TiO₃ | Ilmenite | 6 | Ag, Pd | 1.06 |
| NaTiO₃ | Ilmenite | 6 | Na | 1.02 |
| EuTiO₃ | Ilmenite | 6 | Eu | 1.17 |
| BaTiO₃ | Perovskite | 12 | Ba | 1.35 |
| CaZrO₃ | Perovskite | 12 | Ca | 1.00 |
| SrTiO₃ | Perovskite | 12 | Sr | 1.18 |

Experimental Example 4-1, Experimental Example 4-2, and Experimental Example 4-3, which were conducted using different ceramic raw materials for dielectric layers, will now be described.

### Experimental Example 4-1: Base Component of the Ceramic Material of the Dielectric Layers: BaTiO₃

### 4-1-1. Preparation of a BaTiO₃ Ceramic Raw Material That Will Define the Dielectric Layers

A BaTiO₃ ceramic raw material powder was obtained through the same steps as in the case of Experimental Example 1-1.

### 4-1-2. Preparation of a Conductive Paste for the Formation of Inner Electrodes

A powder of the “ABO₃ oxide” specified in Table 14, which will be provided later, and the above BaTiO₃ ceramic raw material powder for dielectric layers were used as ceramic powders included in the conductive paste for the formation of inner electrodes.

These powders of an “ABO₃ oxide” and BaTiO₃ ceramic raw material powder were weighed out to the “percentages added” specified in Table 14, and a conductive paste for the formation of inner electrodes was prepared through the same steps as in the case of Experimental Example 1-1 above.

Here, the percentage of ceramic powder in the conductive paste for the formation of inner electrodes was set to about 10% by mass.

In Table 14, the ratio of the six-coordinate ionic radius of the A-site element to the six-coordinate ionic radius of the silver/palladium alloy, which was to be included in the inner electrodes, or the “ionic radius ratio (A-site element/Ag_{0.7}Pd_{0.3} alloy),” is presented. For sample 97, the ratio of the six-coordinate ionic radius of the Ba element (about 1.35 Å), indicated in Table 13, to the six-coordinate ionic radius of the silver/palladium alloy (about 1.06 Å) is presented.

### 4-1-3. Production of a Multilayer Ceramic Capacitor

A ceramic slurry including the BaTiO₃ ceramic raw material powder prepared in 4-1-1 above was prepared, and then ceramic green sheets were shaped by applying doctor blading to the ceramic slurry. Then the same steps as in the case of Experimental Example 1-1 were followed to produce a sample multilayer ceramic capacitor.

### 4-1-4. Evaluation

TABLE 14

| | | Percentage added | | | | |
|---|---|---|---|---|---|---|
| | | [% by volume] | | Ionic radius ratio | | |
| | ABO₃ | ABO₃ | | (A-site element/ | Coverage | |
| Sample | oxide | oxide | BaTiO₃ | Ag_{0.7}Pd_{0.3} alloy) | [%] | Assessment |
| 91 | (Ag, Pd)TiO₃ | 100 | 0 | 1.00 | 85 | ∘ |
| 92 | NaTiO₃ | 100 | 0 | 0.96 | 85 | ∘ |
| 93 | EuTiO₃ | 100 | 0 | 1.10 | 84 | ∘ |
| 94 | (Ag, Pd)TiO₃ | 10 | 90 | 1.00 | 83 | ∘ |
| 95 | NaTiO₃ | 10 | 90 | 0.96 | 83 | ∘ |
| 96 | EuTiO₃ | 10 | 90 | 1.10 | 82 | ∘ |
| 97 | — | — | 100 | 1.27 | 75 | x |

The “coverage” was determined as presented in Table 14 following the same procedure as in the case of Experimental Example 1-1 and evaluated as in Experimental Example 1-1.

### 4-1-5. Discussion

Samples 91 to 96 in Table 14 received an “assessment” of “0.” For these samples 91 to 96, the inner electrodes include any of (Ag_{0.7}, Pd_{0.3}) TiO₃, NaTiO₃, or EuTiO₃ as an ABO₃ oxide. The inner electrodes, furthermore, include a silver/palladium alloy as a conductive component.

Ionic radii are focused on here. First, as indicated in the “(Ag,Pd)TiO₃” section in Table 13, the six-coordinate ionic radius of the silver/palladium alloy is about 1.06 Å. The six-coordinate ionic radii of the A-site elements in (Ag_{0.7}, Pd_{0.3}) TiO₃, NaTiO₃, and EuTiO₃ as the ABO₃ oxides included in the inner electrodes of samples 91 to 96, on the other hand, are about 1.06 Å, about 1.02 Å, and about 1.17 Å, respectively, as presented in Table 13.

For samples 91 to 96, which were rated “o,” the ratio of the six-coordinate ionic radius of the A-site element in ABO₃ to the six-coordinate ionic radius of the metals included in the conductive metal particles, or the “ionic radius ratio,” is about 0.96 or greater and about 1.10 or less.

Overall, for (Ag_{0.7}, Pd_{0.3}) TiO₃, NaTiO₃, and EuTiO₃ as the ABO₃ oxides in samples 91 to 96, the six-coordinate ionic radius of the A-site element in ABO₃ is equal to or close to the six-coordinate ionic radius of the silver/palladium alloy as the conductive metal to be included in the inner electrodes. The energy difference between the oxide and the silver/palladium alloy in the inner electrodes, therefore, is about 0 or small, enabling the oxide to remain in the inner electrode portion rather than being expelled. The oxide acts to improve the heat resistance of the inner electrodes. Presumably, as a result of this, samples 91 to 96 achieved a high coverage of about 82% or more.

As can be seen from samples 94 to 96, furthermore, the percentage of (Ag_{0.7}, Pd_{0.3}) TiO₃, NaTiO₃, or EuTiO₃ added is not necessarily about 100%. As long as the percentage was about 10% or more, the advantage of improved coverage was observed compared with when none of (Ag_{0.7}, Pd_{0.3}) TiO₃, NaTiO₃, or EuTiO₃ was included.

In contrast to these, for sample 97, which was rated “x,” only BaTiO₃ as a common material has been added to the inner electrodes. In this case, Ba is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Ba is, as presented in Table 13, about 1.35 Å. Accordingly, the ratio of the six-coordinate ionic radius of Ba to the six-coordinate ionic radius of the silver/palladium alloy, or the “ionic radius ratio,” is about 1.27. As a result, the “ionic radius ratio” fell outside the range of about 0.96 to about 1.10, resulting in a low coverage of about 75%.

For sample 97, the “ionic radius ratio” fell outside the range of about 0.96 to about 1.10, resulting in the expulsion of BaTiO₃ from the inner electrode portion. Presumably, as a result of this, the heat resistance of the inner electrodes was not improved, and the coverage was low.

### Experimental Example 4-2: Base Component of the Ceramic Material of the Dielectric Layers: CaZrO₃

### 4-2-1. Preparation of a CaZrO₃ Ceramic Raw Material That Will Define the Dielectric Layers

A CaZrO₃ ceramic raw material powder was obtained through the same steps as in the case of Experimental Example 1-2.

### 4-2-2. Preparation of a Conductive Paste for the Formation of Inner Electrodes

A powder of the “ABO₃ oxide” specified in Table 15, which will be provided later, and the above CaZrO₃ ceramic raw material powder for dielectric layers were used as ceramic powders included in the conductive paste for the formation of inner electrodes.

These powders of an “ABO₃ oxide” and CaZrO₃ ceramic raw material powder were weighed out to the “percentages added” specified in Table 15, and a conductive paste for the formation of inner electrodes was prepared through the same steps as in the case of Experimental Example 4-1 above.

Here, the percentage of ceramic powder in the conductive paste for the formation of inner electrodes was set to about 10% by mass.

In Table 15, the “ionic radius ratio (A-site element/Ag_{0.7}Pd_{0.3} alloy)” is presented as in the case of Table 14. It should be noted that for sample 107, the ratio of the six-coordinate ionic radius of the Ca element (about 1.00 Å), indicated in Table 13, to the six-coordinate ionic radius of the silver/palladium alloy (about 1.06 Å) is presented.

### 4-2-3. Production of a Multilayer Ceramic Capacitor

A ceramic slurry including the CaZrO₃ ceramic raw material powder prepared in 4-2-1 above was prepared, and then ceramic green sheets were shaped by applying doctor blading to the ceramic slurry. Then the same steps as in the case of Experimental Example 4-1 were followed to produce a sample multilayer ceramic capacitor.

### 4-2-4. Evaluation

TABLE 15

| | | Percentage added | | | | |
|---|---|---|---|---|---|---|
| | | [% by volume] | | Ionic radius ratio | | |
| | | ABO₃ | | (A-site element/ | Coverage | |
| Sample | ABO₃ oxide | oxide | CaZrO₃ | Ag_{0.7}Pd_{0.3} alloy) | [%] | Assessment |
| 101 | (Ag, Pd)TiO₃ | 100 | 0 | 1.00 | 84 | ∘ |
| 102 | NaTiO₃ | 100 | 0 | 0.96 | 84 | ∘ |
| 103 | EuTiO₃ | 100 | 0 | 1.10 | 83 | ∘ |
| 104 | (Ag, Pd)TiO₃ | 10 | 90 | 1.00 | 83 | ∘ |
| 105 | NaTiO₃ | 10 | 90 | 0.96 | 82 | ∘ |
| 106 | EuTiO₃ | 10 | 90 | 1.10 | 81 | ∘ |
| 107 | — | — | 100 | 0.94 | 72 | x |

The “coverage” was determined as presented in Table 15 following the same procedure as in the case of Experimental Example 4-1 and evaluated as in Experimental Example 4-1.

### 4-2-5. Discussion

Samples 101 to 106 in Table 15 received an “assessment” of “0.” For these samples 101 to 106, the inner electrodes include any of (Ag_{0.7},Pd_{0.3})TiO₃, NaTiO₃, or EuTiO₃ as an ABO₃ oxide. The inner electrodes, furthermore, include a silver/palladium alloy as a conductive component.

Ionic radii are focused on here. First, as indicated in the “(Ag, Pd) TiO₃” section in Table 13, the six-coordinate ionic radius of the silver/palladium alloy is about 1.06 Å. The six-coordinate ionic radii of the A-site elements in (Ag_{0.7}, Pd_{0.3}) TiO₃, NaTiO₃, and EuTiO₃ as the ABO₃ oxides included in the inner electrodes of samples 101 to 106, on the other hand, are about 1.06 Å, about 1.02 Å, and about 1.17 Å, respectively, as presented in Table 13.

For samples 101 to 106, which were rated “o,” the ratio of the six-coordinate ionic radius of the A-site element in ABO₃ to the six-coordinate ionic radius of the metals included in the conductive metal particles, or the “ionic radius ratio,” is about 0.96 or greater and about 1.10 or less.

Overall, for (Ag_{0.7}, Pd_{0.3}) TiO₃, NaTiO₃, and EuTiO₃ as the ABO₃ oxides in samples 101 to 106, the six-coordinate ionic radius of the A-site element in ABO₃ is equal to or close to the six-coordinate ionic radius of the silver/palladium alloy as the conductive metal to be included in the inner electrodes. The energy difference between the oxide and the silver/palladium alloy in the inner electrodes, therefore, is about 0 or small, enabling the oxide to remain in the inner electrode portion rather than being expelled. The oxide acts to improve the heat resistance of the inner electrodes. Presumably, as a result of this, samples 101 to 106 achieved a high coverage of about 81% or more.

As can be seen from samples 104 to 106, furthermore, the percentage of (Ag_{0.7}, Pd_{0.3}) TiO₃, NaTiO₃, or EuTiO₃ added is not necessarily about 100%. As long as the percentage was about 10% or more, the advantage of improved coverage was observed compared with when none of (Ag_{0.7}, Pd_{0.3}) TiO₃, NaTiO₃, or EuTiO₃ was included.

In contrast to these, for sample 107, which was rated “x,” only CaZrO₃ as a common material has been added to the inner electrodes. In this case, Ca is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Ca is, as presented in Table 13, about 1.00 Å. Accordingly, the ratio of the six-coordinate ionic radius of Ca to the six-coordinate ionic radius of the silver/palladium alloy, or the “ionic radius ratio,” is about 0.94. As a result, the “ionic radius ratio” fell outside the range of about 0.96 to about 1.10, resulting in a low coverage of about 72%.

For sample 107, the “ionic radius ratio” fell outside the range of about 0.96 to about 1.10, resulting in the expulsion of CaZrO₃ from the inner electrode portion. Presumably, as a result of this, the heat resistance of the inner electrodes was not improved, and the coverage was low.

### Experimental Example 4-3: Base Component of the Ceramic Material of the Dielectric Layers: SrTiO₃

### 4-3-1. Preparation of a SrTiO₃ Ceramic Raw Material That Will Define the Dielectric Layers

A SrTiO₃ ceramic raw material powder was obtained through the same steps as in the case of Experimental Example 1-3.

### 4-3-2. Preparation of a Conductive Paste for the Formation of Inner Electrodes

A powder of the “ABO₃ oxide” specified in Table 16, which will be provided later, and the above SrTiO₃ ceramic raw material powder for dielectric layers were used as ceramic powders included in the conductive paste for the formation of inner electrodes.

These powders of an “ABO₃ oxide” and SrTiO₃ ceramic raw material powder were weighed out to the “percentages added” specified in Table 16, and a conductive paste for the formation of inner electrodes was prepared through the same steps as in the case of Experimental Example 4-1 above.

Here, the percentage of ceramic powder in the conductive paste for the formation of inner electrodes was set to about 10% by mass.

In Table 16, the “ionic radius ratio (A-site element/Ag_{0.7}Pd_{0.3} alloy)” is presented as in the case of Table 14. It should be noted that for sample 117, the ratio of the six-coordinate ionic radius of the Sr element (about 1.18 Å), indicated in Table 13, to the six-coordinate ionic radius of the silver/palladium alloy (about 1.06 Å) is presented.

### 4-3-3. Production of a Multilayer Ceramic Capacitor

A ceramic slurry including the SrTiO₃ ceramic raw material powder prepared in 4-3-1 above was prepared, and then ceramic green sheets were shaped by applying doctor blading to the ceramic slurry. Then the same steps as in the case of Experimental Example 4-1 were followed to produce a sample multilayer ceramic capacitor.

### 4-3-4. Evaluation

TABLE 16

| | | Percentage added | | | | |
|---|---|---|---|---|---|---|
| | | [% by volume] | | Ionic radius ratio | | |
| | | ABO₃ | | (A-site element/ | Coverage | |
| Sample | ABO₃ oxide | oxide | SrTiO₃ | Ag_{0.7}Pd_{0.3} alloy) | [%] | Assessment |
| 111 | (Ag, Pd)TiO₃ | 100 | 0 | 1.00 | 83 | ∘ |
| 112 | NaTiO₃ | 100 | 0 | 0.96 | 83 | ∘ |
| 113 | EuTiO₃ | 100 | 0 | 1.10 | 82 | ∘ |
| 114 | (Ag, Pd)TiO₃ | 10 | 90 | 1.00 | 82 | ∘ |
| 115 | NaTiO₃ | 10 | 90 | 0.96 | 82 | ∘ |
| 116 | EuTiO₃ | 10 | 90 | 1.10 | 80 | ∘ |
| 117 | — | — | 100 | 1.11 | 70 | x |

The “coverage” was determined as presented in Table 16 following the same procedure as in the case of Experimental Example 4-1 and evaluated as in Experimental Example 4-1.

### 4-3-5. Discussion

Samples 111 to 116 in Table 16 received an “assessment” of “o.” For these samples 111 to 116, the inner electrodes include any of (Ag_{0.7},Pd_{0.3})TiO₃, NaTiO₃, or EuTiO₃ as an ABO₃ oxide. The inner electrodes, furthermore, include a silver/palladium alloy as a conductive component.

Ionic radii are focused on here. First, as indicated in the “(Ag, Pd) TiO₃” section in Table 13, the six-coordinate ionic radius of the silver/palladium alloy is about 1.06 Å. The six-coordinate ionic radii of the A-site elements in (Ag_{0.7}, Pd_{0.3}) TiO₃, NaTiO₃, and EuTiO₃ as the ABO₃ oxides included in the inner electrodes of samples 111 to 116, on the other hand, are about 1.06 Å, about 1.02 Å, and about 1.17 Å, respectively, as presented in Table 13.

For samples 111 to 116, which were rated “o,” the ratio of the six-coordinate ionic radius of the A-site element in ABO₃ to the six-coordinate ionic radius of the silver/palladium alloy, or the “ionic radius ratio,” is about 0.96 or greater and about 1.10 or less.

Overall, for (Ag_{0.7}, Pd_{0.3}) TiO₃, NaTiO₃, and EuTiO₃ as the ABO₃ oxides in samples 111 to 116, the six-coordinate ionic radius of the A-site element in ABO₃ is equal to or close to the six-coordinate ionic radius of the silver/palladium alloy as the conductive metal to be included in the inner electrodes. The energy difference between the oxide and the silver/palladium alloy in the inner electrodes, therefore, is about 0 or small, allowing the oxide to remain in the inner electrode portion rather than being expelled. The oxide acts to improve the heat resistance of the inner electrodes. Presumably, as a result of this, samples 111 to 116 achieved a coverage exceeding about 80%.

As can be seen from samples 114 to 116, furthermore, the percentage of (Ag_{0.7}, Pd_{0.3}) TiO₃, NaTiO₃, or EuTiO₃ added is not necessarily about 100%. As long as the percentage was about 10% or more, the advantage of improved coverage was observed compared with when none of (Ag_{0.7}, Pd_{0.3}) TiO₃, NaTiO₃, or EuTiO₃ was included.

In contrast to these, for sample 117, which was rated “x,” only SrTiO₃ as a common material has been added to the inner electrodes. In this case, Sr is twelve-coordinate when it is the A-site element in ABO₃ in the perovskite structure, but when it dissolves in the A-site in the ilmenite structure, the comparison needs to be based on its six-coordinate ionic radius, six being the coordination number of the A-site in the ilmenite structure. The six-coordinate ionic radius of Sr is, as presented in Table 13, about 1.18 Å. Accordingly, the ratio of the six-coordinate ionic radius of Sr to the six-coordinate ionic radius of the silver/palladium alloy, or the “ionic radius ratio,” is about 1.11. As a result, the “ionic radius ratio” fell outside the range of about 0.96 to about 1.10, resulting in a low coverage of 70%.

For sample 117, the “ionic radius ratio” fell outside the range of about 0.96 to about 1.10, resulting in the expulsion of SrTiO₃ from the inner electrode portion. Presumably, as a result of this, the heat resistance of the inner electrodes was not improved, and the coverage was low.

### CONCLUSION

As a result of Experimental Examples 1 to 4 described above, preferred ranges such as the following were discovered for the ratio of the six-coordinate ionic radius of the A-site element in ABO₃ to the six-coordinate ionic radius of the metal included in the conductive metal powder.
(1) Experimental Example 1: about 0.97 to about 1.04
(2) Experimental Example 2: about 0.96 to about 1.04
(3) Experimental Example 3: about 0.89 to about 1.02
(4) Experimental Example 4: about 0.96 to about 1.10

The metal species of the conductive metal powder varies: nickel in Experimental Example 1, copper in Experimental Example 2, silver in Experimental Example 3, and a silver/palladium alloy in Experimental Example 4. Even if the metal species varies in such a manner, however, there is a common range regarding appropriate ratios between the ionic radii. This common range was used to define the scope of the present invention. Example embodiments of the present invention, therefore, includes a powder made of an ABO₃-type oxide for which the ratio of the six-coordinate ionic radius of the A-site element in ABO₃ to the six-coordinate ionic radius of a metal included in a conductive metal powder is, for example, about 0.97 or greater and about 1.02 or less.

In the experimental examples described above, the conductive metal powder included in the conductive paste for the formation of inner electrodes was, for example, a nickel powder, a copper powder, a silver powder, or a silver/palladium alloy powder. A powder other than these, however, can also be used as the conductive metal powder. The ABO₃-type oxide with a specified ionic radius, furthermore, can be any kind of ABO₃-type oxide, as long as the ratio of the six-coordinate ionic radius of the A-site element in ABO₃ to the six-coordinate ionic radius of the metal included in the conductive metal powder included in the conductive paste is, for example, about 0.97 or greater and about 1.02 or less.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A conductive paste for forming inner electrodes of a multilayer ceramic capacitor, the conductive paste comprising:
a conductive metal powder;
a ceramic powder;
an organic solvent; and
an organic binder; wherein
at least a portion of the ceramic powder includes a powder including an ABO₃-type oxide with a specified ionic radius; and
a ratio of a six-coordinate ionic radius of an A-site element in ABO₃ to a six-coordinate ionic radius of a metal included in the conductive metal powder is about 0.97 or greater and about 1.02 or less.

2. The conductive paste according to claim 1, wherein the ABO₃-type oxide with the specified ionic radius has an ilmenite crystal structure.

3. The conductive paste according to claim 1, wherein the conductive metal powder includes one of nickel, copper, silver, or a silver/palladium alloy.

4. The conductive paste according to claim 1, wherein
about 10% by volume or more of the ceramic powder includes the powder including the ABO₃-type oxide with the specified ionic radius; and
a remainder of the ceramic powder includes a powder including at least one of BaTiO₃, SrTiO₃, or CaZrO₃ as a base component.

5. The conductive paste according to claim 4, wherein the remainder of the ceramic powder includes at least one of Mn, Mg, Si, Y, Dy, or Gd as a minor component.

6. The conductive paste according to claim 1, wherein a percentage of the ceramic powder in about 5% by mass or more and about 15% by mass or less of the conductive paste.

7. The conductive paste according to claim 3, wherein the conductive metal powder includes nickel.

8. The conductive paste according to claim 3, wherein the conductive metal powder includes copper.

9. The conductive paste according to claim 3, wherein the conductive metal powder includes silver.

10. The conductive paste according to claim 3, wherein the conductive metal powder includes a silver/palladium alloy.

11. A multilayer ceramic capacitor comprising:
a multilayer body including a plurality of ceramic dielectric layers stacked together and a plurality of inner electrodes extending along a plurality of interfaces between the plurality of dielectric layers; wherein
the plurality of inner electrodes include a conductive component and a ceramic component, and at least a portion of the ceramic component includes an ABO₃-type oxide with a specified ionic radius; and
a ratio of a six-coordinate ionic radius of an A-site element in ABO₃ to a six-coordinate ionic radius of a metal included in the conductive component is about 0.97 or greater and about 1.02 or less.

12. The multilayer ceramic capacitor according to claim 11, wherein the ABO₃-type oxide with the specified ionic radius has an ilmenite crystal structure.

13. The multilayer ceramic capacitor according to claim 11, wherein the conductive component includes one of nickel, copper, silver, or a silver/palladium alloy.

14. The multilayer ceramic capacitor according to claim 11, wherein
about 10% by volume or more of the ceramic component includes a powder including the ABO₃-type oxide with the specified ionic radius; and
a remainder of the ceramic component includes a powder including at least one of BaTiO₃, SrTiO₃, or CaZrO₃ as a base component.

15. The multilayer ceramic capacitor according to claim 14, wherein the remainder of the ceramic component includes at least one of Mn, Mg, Si, Y, Dy, or Gd as a minor component.

16. The multilayer ceramic capacitor according to claim 11, wherein a percentage of the ceramic component in about 5% by mass or more and about 15% by mass or less of the plurality of inner electrodes.

17. The multilayer ceramic capacitor according to claim 13, wherein the conductive component includes nickel.

18. The multilayer ceramic capacitor according to claim 13, wherein the conductive component includes copper.

19. The multilayer ceramic capacitor according to claim 13, wherein the conductive component includes silver.

20. The multilayer ceramic capacitor according to claim 13, wherein the conductive component includes a silver/palladium alloy.
